(19) United States
(12) Patent Application Publication
(10) Pub. No.: US 2007/0224020 A1
(43) Pub. Date: Sep. 27, 2007

(54) Screw

(76) Inventors: Jui-Tse Hsieh, Sinshih Township (TW); Chiu-Yueh Wang, Gangshan Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/405,409

(22) Filed: Apr. 18, 2006

(30) Foreign Application Priority Data
Mar. 24, 2006 (TW) 095205011

(51) Int. Cl. F16B 35/06

(52) U.S. Cl. 411/399

(57) ABSTRACT

A screw includes an enlarged head and a threaded shank longitudinally extending from said head; said head has a bottom surface with a plurality of ribs protruded therefrom so as to provide with high frictional resistance and waterproof effect when screwing in. Further, the ratio of the outer diameter of head to the outer diameter of shank is 1:3.5˜5.5. Accordingly the head has greater areas to cover the ejected debris of object so as to maintain clean appearance.

### BACKGROUND OF THE INVENTION

1. Field of the Invention

The present invention relates to a screw with a enlarge head wherein a plurality of ribs is arranged on the undersurface thereof, in particularly to provided with high frictional resistance and waterproof effect.

2. Description of the Related Art

Referring to FIG. 1, a conventional screw 1 comprises a head 11 and a shank 12 extending therefrom. Said shank 12 has a threaded portion 13 and a drilling portion 14. The drilling portion 14 has two cut grooves 141 disposed thereon. A cutting edge 142 is defined on the boundary of the cut grooves 141 and the outer periphery of the drilling portion 14. In use, said cutting edges 142 cut the object 2 so as to bring the screw in.

In use, the conventional screw has several defects.
1. Generally, the ratio of the outer diameter of the head to the outer diameter of said shank is 1:2 so that the head has relatively less areas to cover the debris of object ejected out from the drilling hole.
2. Due to the ejected debris, the bottom surface is difficult to closely contact with the object which result of seeping of the water. Consequently, the screw tends to become rusty easily.

### SUMMARY OF THE INVENTION

Therefore, the object of present invention is to provide a screw, which includes enlarged head with a plurality of ribs defined on the undersurface thereof, that is capable of overcoming the aforesaid drawback of the prior art.

The present invention relates to a screw that comprises an enlarged head and a threaded shank longitudinally extending from said head; said head has an upper surface and an opposite bottom surface with a plurality of ribs protruded therefrom so as to provide with high frictional resistance and waterproof effect when screwing in. Further, the ratio of the outer diameter of said head to the outer diameter of said shank is 1:3.5˜5.5. Accordingly the head has more areas to cover the ejected debris of object for maintaining clean appearance.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional screw screwed in the object;

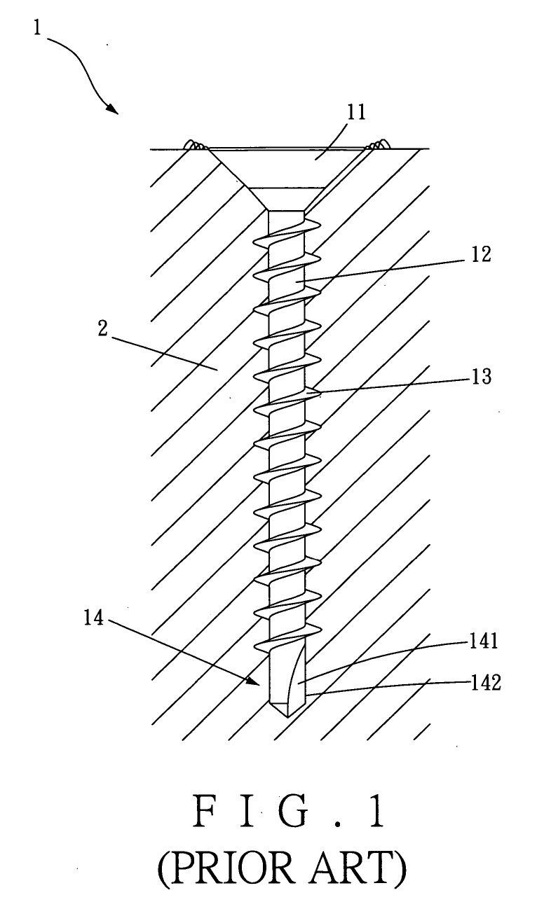

FIG. 2 is a perspective view to show the first embodiment of screw according to the present invention;

FIG. 3 shows the first embodiment of screw screwed in the object;

FIG. 4 is a perspective view to show the second embodiment of screw according to the present invention;

FIG. 5 shows the second embodiment of screw screwed in the object;

FIG. 6 is a perspective view to show the third embodiment of screw according to the present invention.

### DETAILED DESCRIPTION OF THE PREFERRED EMBODIMENTS

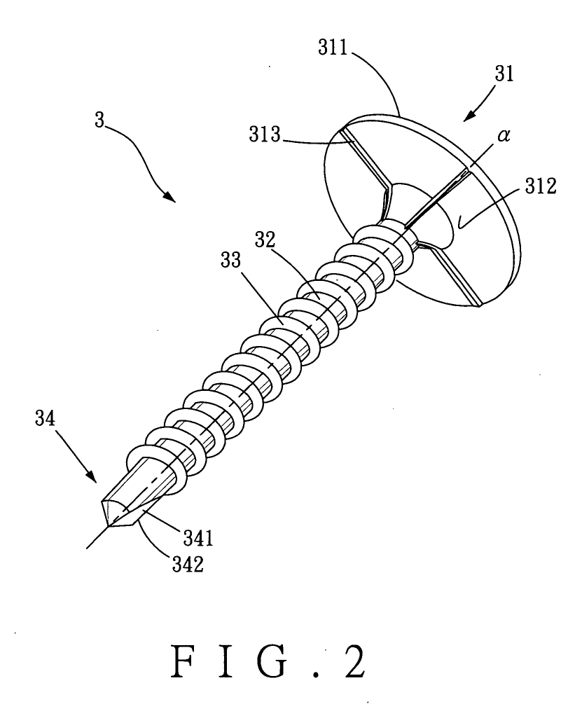

Referring to FIG. 2, the screw 3 of the present invention comprises an enlarged head 31 and a shank 32 longitudinally extending from the head 31; Said head 31 includes an upper surface 311 and opposite bottom surface 312. A plurality of ribs 313 are arranged on the bottom surface 312 and radiated outward from shank axial line α. Each of said ribs 313 is properly extending from bottom surface 312 onto the shank 32. The ratio of the outer diameter of said head 31 to the outer diameter of said shank 32 is 1:3.5˜5.5 (FIG. 2 show the ratio 1:3.5). The shank 32 includes an axially extended thread 33 in the outer periphery thereof and a drilling portion 34 defined at the distal end thereof. At least one cut groove 341 is defined on the drilling portion 34 in which forms a cutting edge 342 between said cut groove 341 and the outer periphery of drilling portion 34.

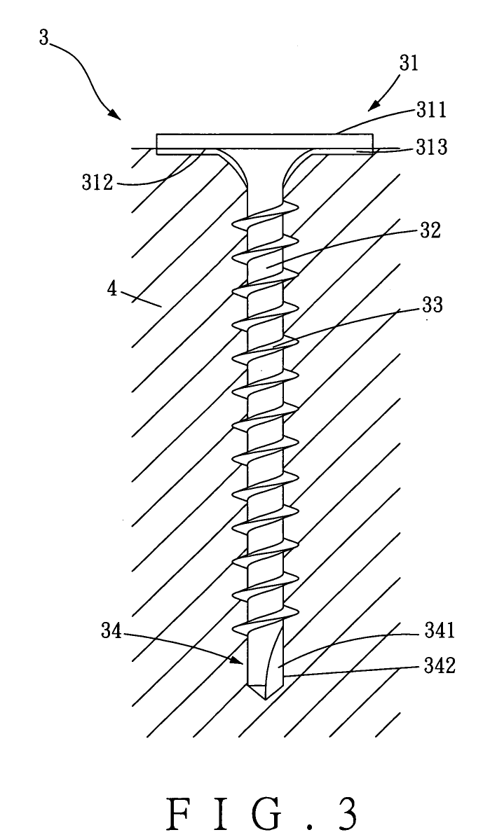

As shown in FIG. 3, during the operation, the head 31 is given a torque to rotate the cutting edge 342 to cut the object 4. At the same time, the debris of object ejected out along with the threads 33. When screwing into the object 4, the enlarged head 31 closely contact with the surface of object 4 and provide with a function of hiding the debris behind. Besides, the ribs 313 arranged on the bottom surface 312 of head ensure the good resistance of extraction and prevent the water from seeping in.

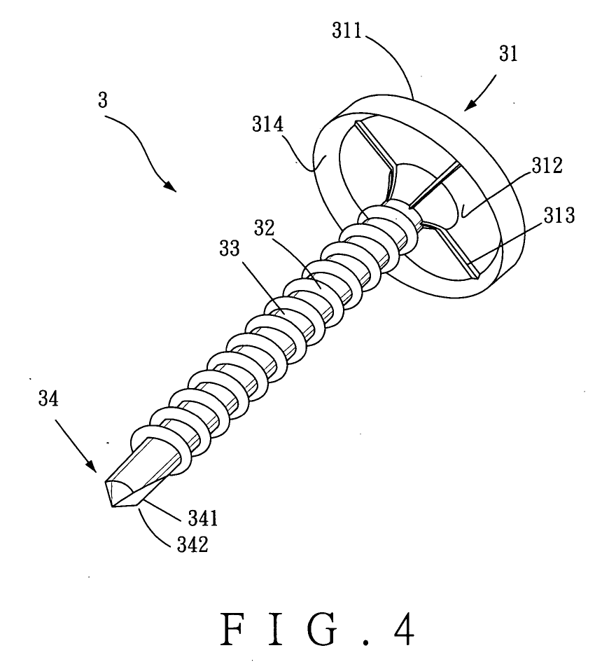

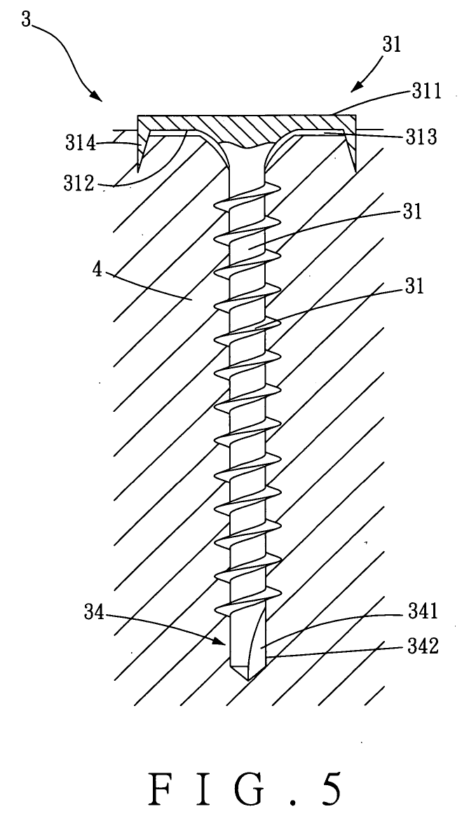

Referring to FIG. 4, the second embodiment of the present invention according to the screw 3, wherein said bottom surface 312 has a cutting ring 314 extending from the outer periphery thereof. Said cutting ring 314 provide with a sharp end. As shown in FIG. 5, during the operation, the cutting ring 314 is able to cut a circumference on the surface of object 4 that is facilitated to merge the head 31 in the object 4 so as to prevent undesired destruction of object 4.

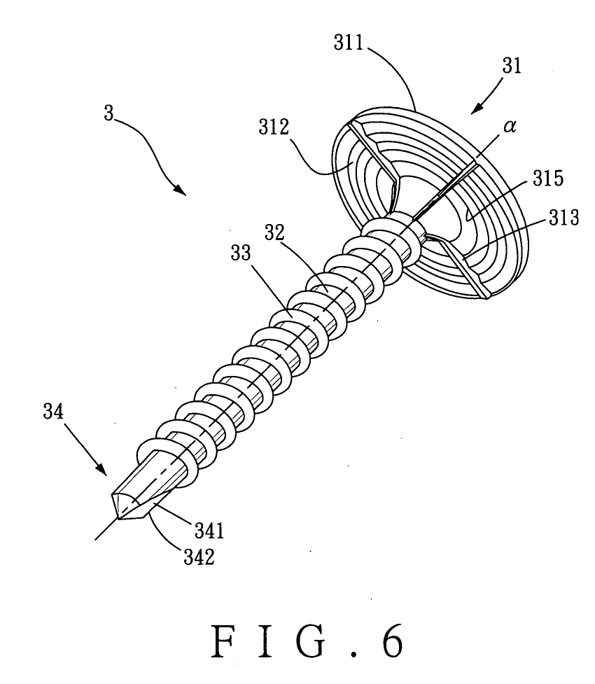

As illustrated in FIG. 6, the third embodiment of the present invention according to the screw 3, wherein said bottom surface 312 has a plurality of annular ribs 315 arranged thereon about the shank axial line α. When screwing, each of said annular ribs 315 firmly engaged with the object 4 so as to block the water to seep in.

To sum up with above description, the present invention provides the following advantages:
1. Due to the reason that ratio of the outer diameter of head to the outer diameter of shank is 1:3.5˜5.5 so that the head provided with a board area to cover the debris and thereby the appearance is skillfully and cleanly kept.
2. By means that a plurality of ribs engaged on the surface of object, the head is able to block the water so as to prevent the screw from becoming rusty.
3. By means of the cutting ring, said head is able to merge in the object completely so as to avoid the object to be squeezed by the head which result of the destruction of object.

While we have shown and described the embodiment in accordance with the present invention, it should be clear to those skilled in the art that further embodiments may be made without departing from the scope of the present invention.

1. A screw comprising:
an enlarged head having an upper surface and a bottom surface defined opposite to the upper surface;
a shank longitudinally extending from the bottom surface of said head, and including an axially extended thread in an outer periphery thereof and a drilling portion defined at a distal end thereof, wherein the ratio of the outer diameter of said head to the outer diameter of said shank is being 1:3.5˜5.5;
a conical section defined on said bottom surface of said enlarged head, said conical section connecting said head and said shank, said bottom surface having a plurality of ribs radially arranged thereon extending from the outer periphery of said bottom surface, over said conical section and terminating in contact with said shank.

2. The screw as claimed in claim 1, wherein said bottom surface has a cutting ring extending from the outer periphery thereof, said cutting ring provided with a sharp end.

3. The screw as claimed in claim 1, wherein the bottom surface has a plurality of annular ribs along the shank axial line.

4. (canceled)
